(19) United States
(12) Patent Application Publication
(10) Pub. No.: US 2006/0027716 A1
(43) Pub. Date: Feb. 9, 2006

(54) Fitting for connecting plates, particularly shelves or trays

(76) Inventor: Rudiger Walz, Haigerloch (DE)

Correspondence Address: Friedrich Kueffner, Suite 910, 317 Madison Avenue, New York, NY, 10017, US

(21) Appl. No.: 11/198,844

(22) Filed: Aug. 5, 2005

(30) Foreign Application Priority Data
Aug. 6, 2004 (DE) 20 2004 012 350.9

(51) Int. Cl. F16L 3/00

(52) U.S. Cl. 248/73

(57) ABSTRACT

A fitting for connecting plates, particularly shelves or trays, includes a support member insertable into a recess of one part, wherein a fastening member connected to the other part is slidable approximately in the axial direction into the support member. Supported in the support member is a clamping part which is rotatable from a release position into a locking position and which is provided with two gripping arms located one above the other and constructed as clamping cams. At least in the locking position of the clamping part, the gripping arms engage behind the head of a tightening bolt arranged on the fastening part approximately transversely of the axial direction. The support surface for the tightening bolt of the lower gripping arm in the direction of insertion of the support member ascends at least partially in the direction of locking of the clamping part.

### BACKGROUND OF THE INVENTION

1. Field of the Invention

The present invention relates to a fitting for connecting plates, particularly shelves or trays, with a support member insertable into a recess of one part, wherein a fastening member connected to the other part is slidable approximately in axial direction into the support member.

2. Description of the Related Art

In a known embodiment of the above-described type, a locking disk is rotatably mounted in the support member, wherein the locking disk engages into a groove of the fastening member. The support surface of the groove and the contact surface of the locking disk ascend in opposite directions, so that the fastening member is axially pressed against the support member.

In another fitting of this type, the fastening member is composed of a bolt with a recess, wherein a locking member rotatably mounted in the support member engages in the recess of the bolt. While this makes it possible that the bolt can be tightened in the vertical as well as the horizontal direction, the bolt is tensioned transversely of its direction of insertion, so that shear forces act on the bolt.

### SUMMARY OF THE INVENTION

It is the object of the present invention to achieve a contact pressure between the parts of the connecting fitting and, thus, of the plates or the like, in the longitudinal direction as well as in the transverse direction of the connecting fitting, without having any gravity forces act on the components.

In accordance with the present invention, supported in the support member is a clamping part which is rotatable from a release position into a locking position and which is provided with two gripping arms located one above the other and constructed as clamping cams. At least in the locking position of the clamping part, the gripping arms engage behind the head of a tightening bolt arranged on the fastening part approximately transversely of the axial direction. The support surface for the tightening bolt of the lower gripping arm in the direction of insertion of the support member ascends at least partially in the direction of locking of the clamping part.

The support member is preferably approximately tubular and is slotted at least partially in the axial direction, so that the tightening bolt can engage in the clamping part. The clamping part additionally includes an axially extending groove for receiving the fastening member.

For reasons of stability and for supporting the clamping member, a transverse floor is provided which is additionally reinforced by an axially extending transverse wall. The clamping member itself has at the lower end thereof a guide pin with locking disk and the floor has a corresponding recess, wherein the locking disk engages under the floor at least in the locking position of the clamping member in order to ensure the mutual axial tightening of the parts.

The support member is preferably provided for its support with a plate to be fastened, wherein the plate includes one or more laterally protruding plate-shaped wings with recesses for screws or the like. The fastening member is constructed as a cover plate which protrudes beyond the support member and which is provided with a leg which extends perpendicularly of the cover plate and is insertable into the groove of the support member, wherein the leg supports the tightening bolt and its head, wherein tightening bolt is directed approximately transversely of the longitudinal axis of the leg. As a result of the plate-shaped configuration, the screws used for fastening the support member can be covered. The leg has at least one, particularly two, recesses for fastening screws or the like. The cover plate additionally has a throughopening and the clamping member has at its end facing away from the bearing pin one or more slots for the engagement of a tool.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective view of an assembled connecting fitting;

FIG. 2 is an exploded view showing the fitting of FIG. 1 in a front view on a smaller scale;

FIG. 3 is a perspective rear view of the support member with a fastening member mounted above the support member;

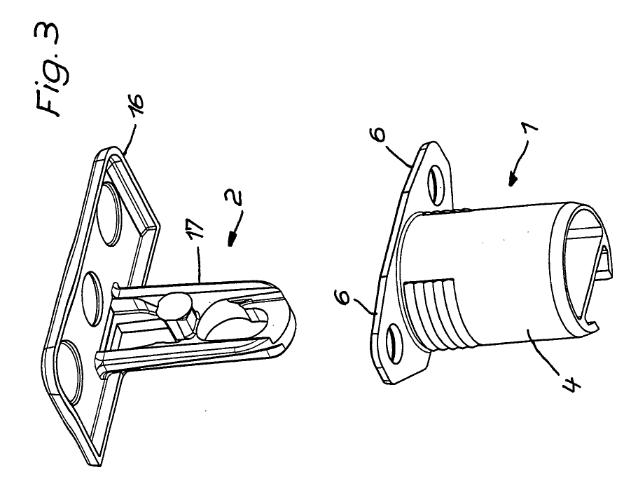

FIG. 4 is a front view corresponding to FIG. 3 with inserted fastening screws;

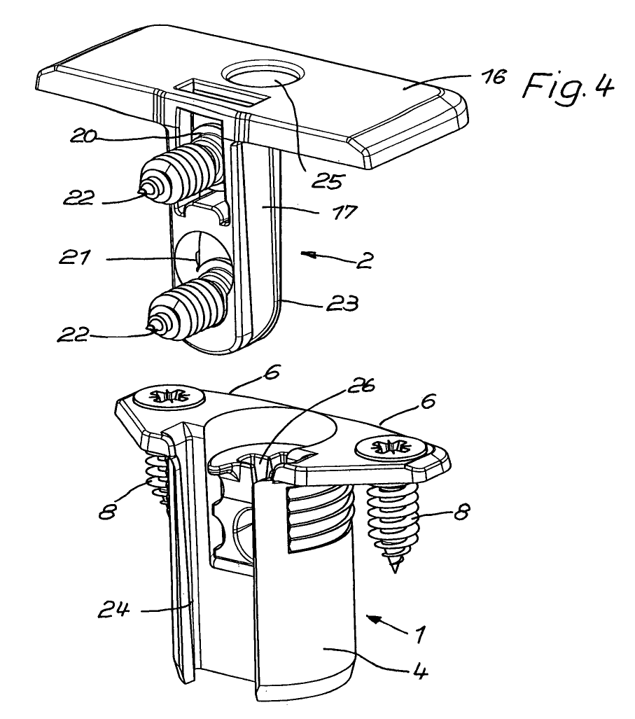

FIG. 5 is a cross-sectional view corresponding to FIG. 1 showing the clamping member in the released position; and

FIG. 6 is a sectional view corresponding to FIG. 5, showing the locking position of the clamping part.

### DETAILED DESCRIPTION OF THE INVENTION

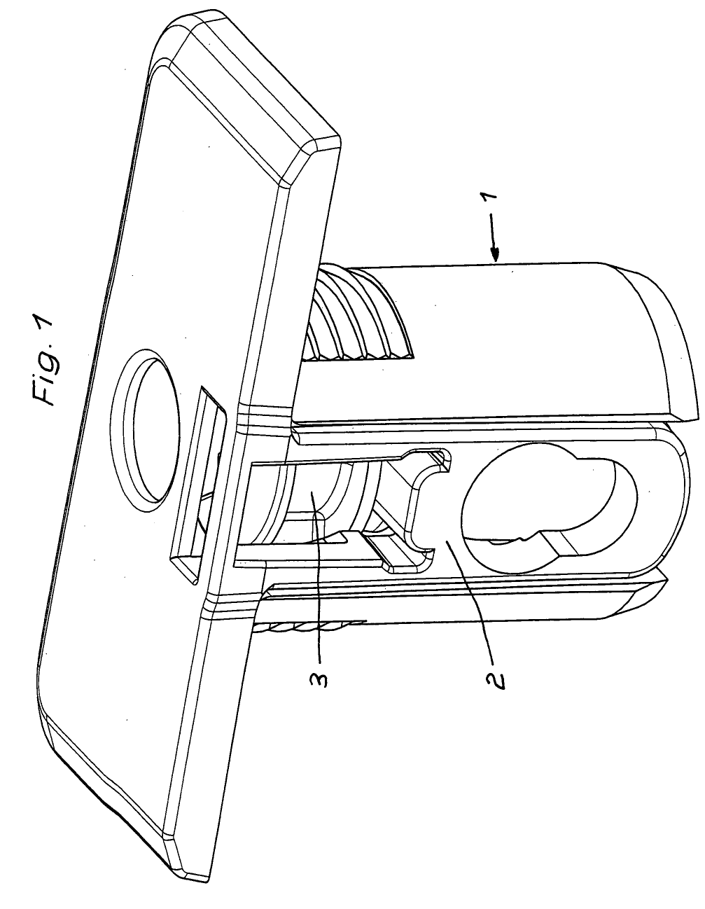

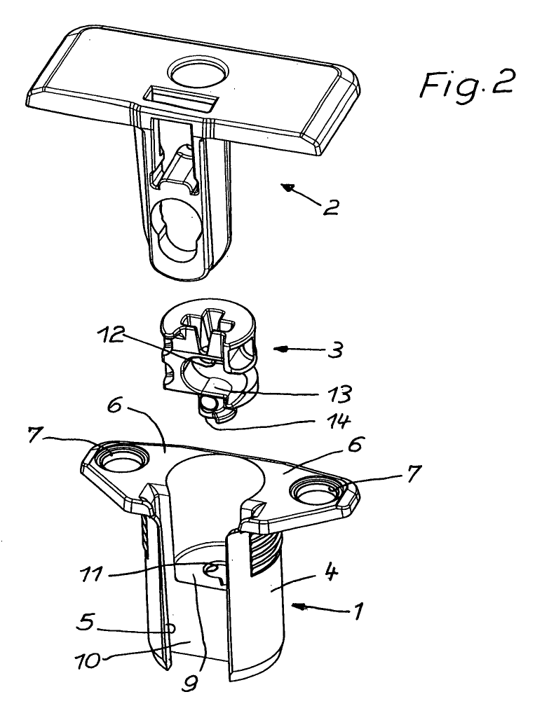

As seen in FIGS. 1 and 2 of the drawing, the connecting fitting is composed of three parts, namely, the support member 1, the fastening member 2, and the clamping member 3.

The support member is composed of a tubular base body 4 which has a longitudinal slot 5 extending in the axial direction thereof. Particularly for the connection of honeycomb-type plates, two laterally protruding plate-shaped wings 6 with recesses 7 for fastening screws 8 are provided at the upper end of the tubular base body 4. The support member rests with these wings on the surface of a plate, not shown, and is connected to the plate by means of the screws 8. A transverse floor 9, which is additionally supported by an axially extending transverse wall 10, is arranged approximately in the middle of the tubular base body 4. The transverse floor 9 has a recess 11 for the clamping part 3.

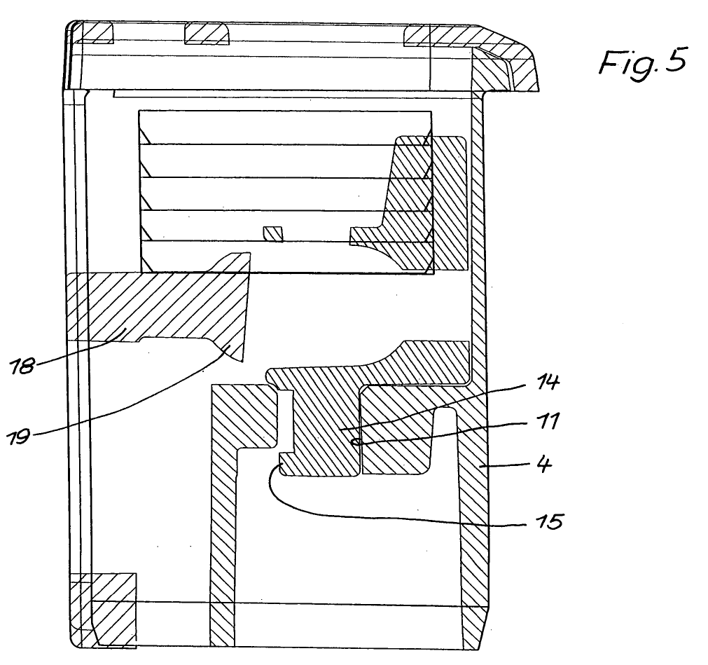

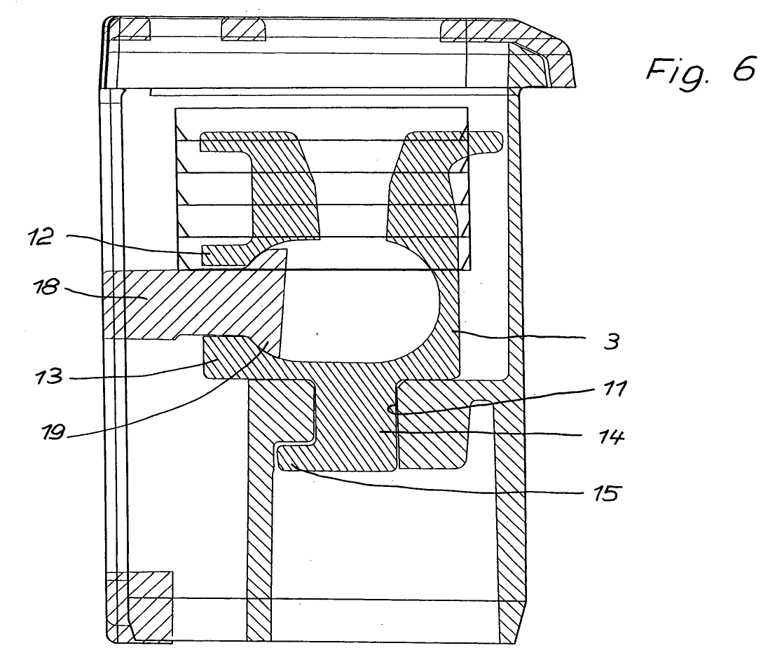

The clamping part 3 is rotatably mounted in the tubular base body 4 on the transverse floor 9 and is provided with two gripping arms 12 and 13 which are constructed as clamping cams and are located one above the other. At its lower end, a bearing pin 14 is provided which engages in the recess 11 of the transverse floor 9 and engages under the transverse floor with a locking disk 15 at least in the locking position of the connecting fitting. As shown in FIGS. 2, 5 and 6, the recess 11 is shaped in such a way that, at least in the release position according to FIG. 5, the clamping part 3 can be inserted with the bearing pin 14 and the locking disk 15 in the recess 11 of the floor part 9. In the case of a rotation of the floor into the locking position according to FIG. 6, the locking disk 15 engages underneath the transverse floor 9, so that the clamping part 3 is held in its exact axial position.

The fastening member 2 is composed of a plate 16 which covers the support member 1 with its wings 6 and of a leg 17 which extends perpendicularly of the plate 16. Arranged on the leg 17 is a tightening bolt 18 with a head 19 for engagement in the clamping part 3. The leg 17 has a tightening bolt 18 with a head 19 for engagement in the clamping part 3, wherein the tightening bolt 18 extends transversely of the axial direction and faces inwardly. The leg 17 additionally has two recesses 20 and 21 for receiving fastening screws 22. The leg 17 is additionally provided at its rear edge with a guide rail 23 which can be inserted into a guide groove 24 of the support member 1 as long as the clamping part 3 is in the release position shown in FIG. 5. When the clamping part 3 is turned clockwise, the head 19 of the tightening bolt 18 is engaged by the gripping arms 12 and 13 of the clamping part 3 and is pulled with the fastening part 2 against the support member 1. The support surface of the lower gripping arm 13 ascends in the direction of rotation, so that the fastening part is also pulled against the support member in the axial direction. This means that, in the vertical direction as well as in the horizontal direction, a fixed connection of the parts to each other is achieved which is also transferred to the plates which are connected to the parts, but are not illustrated. The parts can also be separated from each other without problems by turning the clamping member back from the locking position according to FIG. 6 into the release position according to FIG. 5.

In order to facilitate an easy adjustment of the clamping member, the cover plate 16 has a recess 25 and the clamping member has one or more slots 26 for the engagement of a tool.

While specific embodiments of the invention have been shown and described in detail to illustrate the inventive principles, it will be understood that the invention may be embodied otherwise without departing from such principles.

I claim:

1. A fitting for connecting plates, the fitting comprising a support member adapted to be insertable into a recess of one part, and a fastening member connected to the other part is slidable approximately in an axial direction into the support member, further comprising a clamping part mounted in the support member so as to be rotatable between a release position and a locking position, wherein the clamping part has two gripping arms located one above the other and configured as clamping cams, wherein, at least in the locking position of the clamping part, the gripping arms engage behind a head of a tightening bolt arranged on the fastening part approximately transversely of the axial direction, and wherein a support surface for the tightening bolt of the lower gripping arm in the direction of insertion of the support member ascends at least partially in the direction of locking of the clamping part.

2. The fitting according to claim 1, wherein the support member has an approximately axially extending groove for receiving the fastening member.

3. The fitting according to claim 1, wherein the support member is approximately tubular and is at least partially slotted in the axial direction.

4. The fitting according to claim 3, wherein the support member has a transverse floor for supporting the clamping part.

5. The fitting according to claim 4, wherein the transverse floor is supported by an axially extending transverse wall.

6. The fitting according to claim 4, wherein the clamping part has at a lower end thereof a bearing pin with locking disk and the transverse floor has a corresponding recess, and wherein the locking disk engages under the transverse floor at least in the locking position of the clamping part.

7. The fitting according to claim 1, wherein, for support on a plate to be fastened, the support member has one or more naturally protruding plate-shaped wings with recesses for screws.

8. The fitting according to claim 2, wherein the fastening member comprises a cover plate protruding above the support member, wherein the cover plate includes a perpendicularly extending leg which is insertable into the groove of the support member, wherein the leg supports the tightening bolt with head extending approximately transversely of its longitudinal axis.

9. The fitting according to claim 8, wherein the leg has at least one recess for fastening screws.

10. The fitting according to claim 8, wherein the cover plate has a throughopening and the clamping part has at an end opposite the bearing pin one or more slots for the engagement of a tool.
